(19) United States
(12) Patent Application Publication
(10) Pub. No.: US 2024/0169617 A1
(43) Pub. Date: May 23, 2024

(54) Computer Vision Systems and Methods for Information Extraction from Floorplan Images

(71) Applicant: Insurance Services Office, Inc., Jersey City, NJ (US)

(72) Inventors: Zheng Zhong, Seattle, WA (US); Aurobrata Ghosh, Pondicherry (IN); Venkata Subbarao Veeravasarapu, Munich (DE); Shane De Zilwa, Danville, CA (US)

(73) Assignee: Insurance Services Office, Inc., Jersey City, NJ (US)

(21) Appl. No.: 18/517,225

(22) Filed: Nov. 22, 2023

Related U.S. Application Data
(60) Provisional application No. 63/427,542, filed on Nov. 23, 2022.

(51) Int. Cl. G06T 11/20; G06F 16/51; G06F 16/583; G06F 40/295; G06V 30/14; G06V 30/148; G06V 30/19; G06V 30/422

(52) U.S. Cl. CPC G06T 11/206; G06F 16/51; G06F 16/5854; G06F 40/295; G06V 30/1448; G06V 30/148; G06V 30/19; G06V 30/422

(57) ABSTRACT

Computer vision systems and methods for information extraction from floorplan images are provided. The system generates a multi-attributed graph representing an architectural floorplan image having nodes representing rooms of the floorplan image and connecting edges therebetween representing connectivity between the rooms. Each node of the multi-attributed graph can have multiple attributes including a type of the room, a room size, and the floor number on which room lies. Each edge can have attributes to denote a type of connectivity, such as door-based, wall-based, wall-with-window-based, and vertical connectivity where one room is located beneath another room on a separate floor of the floorplan image.

### RELATED APPLICATIONS

This application claims priority to U.S. Provisional Patent Application Ser. No. 63/427,542 filed on Nov. 23, 2022, the entire disclosure of which is hereby expressly incorporated by reference.

### TECHNICAL FIELD

The present disclosure relates generally to the field of computer vision technology. More specifically, the present disclosure relates to computer vision systems and methods for information extraction from architectural floorplan images.

### RELATED ART

Architectural floorplan analysis of a building structure is a function performed by many industries as an essential step to several downstream applications. For example, in the insurance field, architectural floorplan analysis is performed to extract information about one or more rooms in a given structure, such as the their dimensions, arrangement, and connectivity. This information is then utilized in connection with performing risk assessments, evaluations, and other related tasks. Currently, architectural floorplan analysis is performed manually, or with the aid of computerized systems. However, the analysis can be a time-consuming task when performed manually, and can be inaccurate and incomplete when performed by existing computerized systems.

Furthermore, computerized systems may require that the floorplan be provided as a computerized model (e.g., SolidWorks, AutoCAD, etc.), which may not be available. Further still, converting existing floorplan images into a computerized model for information extraction can also pose several challenges, such as, for example, variations in the software programs that generate floorplan documents, watermarks and other background text and objects, font sizes and styles, color code variations, structures with multiple floors, disconnected components within the same floor, and the like.

Accordingly, what would be desirable, but have not yet been provided, are systems and methods which solve the foregoing and other needs.

### SUMMARY

The present disclosure relates to computer vision systems and methods for information extraction from floorplan images. Specifically, the present disclosure includes systems and methods for generating a multi-attributed graph representing an architectural floorplan image having nodes representing rooms of the floorplan image and connecting edges therebetween representing connectivity between the rooms. Each node of the multi-attributed graph can have multiple attributes including a type of the room, a room size, and the floor number on which room lies. Each edge can have attributes to denote a type of connectivity, such as door-based, wall-based, wall-with-window-based, and vertical connectivity where one room is located beneath another room on a separate floor of the floorplan image.

The systems and methods of the present disclosure generate the multi-attributed graph by receiving a floorplan image, applying object detection to identify individual floors shown on the floorplan image, applying segmentation to the identified floors of the floorplan image to identify entities of the individual floors, extracting text and performing named entity recognition to identify types of entities, performing data association between the segmented entities and the recognized entity types, creating a node for each recognized entity, and creating edges between the recognized entities based on a connectivity therebetween. According to some embodiments, the system can create a node with a corresponding room type index for each significant segment in the segmentation output. In creating edges between the nodes, the system can determine which rooms are connected by a door, using morphological operators, and the direction of the edge can indicate which room the door opens into. Additionally, the system can compute an overlap between vertically aligned segmented entities and generate an edge indicating vertical alignment of rooms on various floors. In creating the node attributes, the system uses named entity recognition to determine the type of the room, extracts size-related text, and determines which room the size-related text applies to.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating computer hardware and network components of the system of the present disclosure;

FIG. 2 is another diagram illustrating hardware and software components of the system of the present disclosure;

FIG. 3 is a flowchart illustrating process steps carried out by the system of the present disclosure;

FIG. 4 is another flowchart illustrating additional process steps carried out by the system of the present disclosure in connection with generating a multi-attributed graph for a single floor of floorplan image;

FIG. 5 is another flowchart illustrating additional process steps carried out by the system of the present disclosure in connection with merging multi-attributed graphs of a floorplan image;

FIG. 6 is a diagram illustrating an exemplary floorplan image received by the system of the present disclosure;

FIG. 7 is a diagram illustrating bounding boxes applied to the exemplary floorplan image of FIG. 6;

FIG. 8 is a diagram illustrating another exemplary floorplan image received by the system of the present disclosure;

FIG. 9 is a diagram illustrating a segmentation map applied to the floorplan image of FIG. 8;

FIG. 10 is a diagram illustrating application of optical character recognition by the system of the present disclosure to the floorplan image of FIG. 8;

FIG. 11 is a diagram illustrating application of named entity recognition by the system of the present disclosure to the floorplan image of FIG. 8; and

FIG. 12 is a diagram illustrating an exemplary multi-attributed graph generated by the system 10 of the present disclosure and representing the floorplan image of FIG. 6.

### DETAILED DESCRIPTION

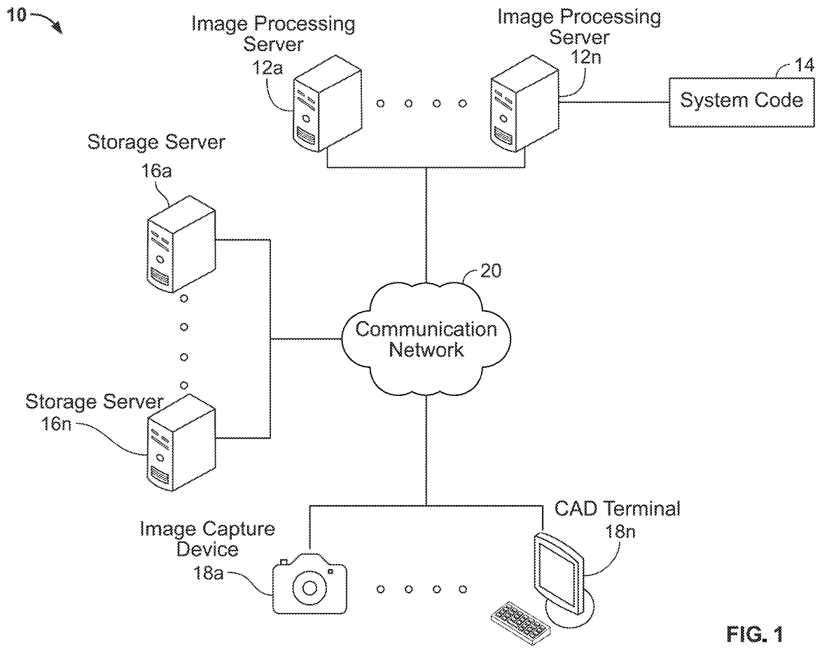

The present disclosure relates to computer vision systems and methods for information extraction from floorplan images, as described in detail below in connection with FIGS. 1-12. Specifically, the present disclosure relates to computer vision systems and methods for information extraction from architectural floorplan images and the generation of multi-attributed graphical representations of said architectural floorplan images.

FIG. 1 is a diagram illustrating computer hardware and network components on which a system 10 of the present disclosure could be implemented. The system 10 can include a plurality of image processing servers 12a-12n having at least one processor and memory for executing the computer instructions and methods described herein (which could be embodied as system code 14). The system 10 can also include a plurality of storage servers 16a-16n for receiving and storing one or more architectural floorplan images, models, and/or other data generated by the system 10. It should be understood that the plurality of image processing servers 12a-12n and the plurality of storage servers 16a-16n could each include, but are not limited to, a personal computer, a laptop computer, a tablet computer, a smart telephone, a server, and/or a cloud-based computing platform. The system 10 can also include a plurality of floorplan image generation devices 18a-18n for capturing and/or generating architectural images and/or models of floorplans. For example, the devices can include, but are not limited to, an image capture device (e.g., camera, scanner, etc.) for digitizing an existing floorplan document, such as a blueprint, or a CAD terminal for generating a floorplan model that is subsequently exported as an (e.g., rasterized) image. The image processing servers 12a-12n, the storage servers 16a-16n, and the floorplan image generation devices 18a-18n can communicate over a communication network 20. Of course, the system 10 need not be implemented on multiple devices, and indeed, the system 10 could be implemented on a single computer system (e.g., a personal computer, server, mobile computer, smart phone, etc.) without departing from the spirit or scope of the present disclosure.

Still further, the system 10 could be embodied as a customized hardware component such as a field-programmable gate array (“FPGA”), application-specific integrated circuit (“ASIC”), embedded system, or other customized hardware component without departing from the spirit or scope of the present disclosure. It should also be understood that FIG. 1 is only one potential configuration, and the system 10 of the present disclosure can be implemented using a number of different configurations.

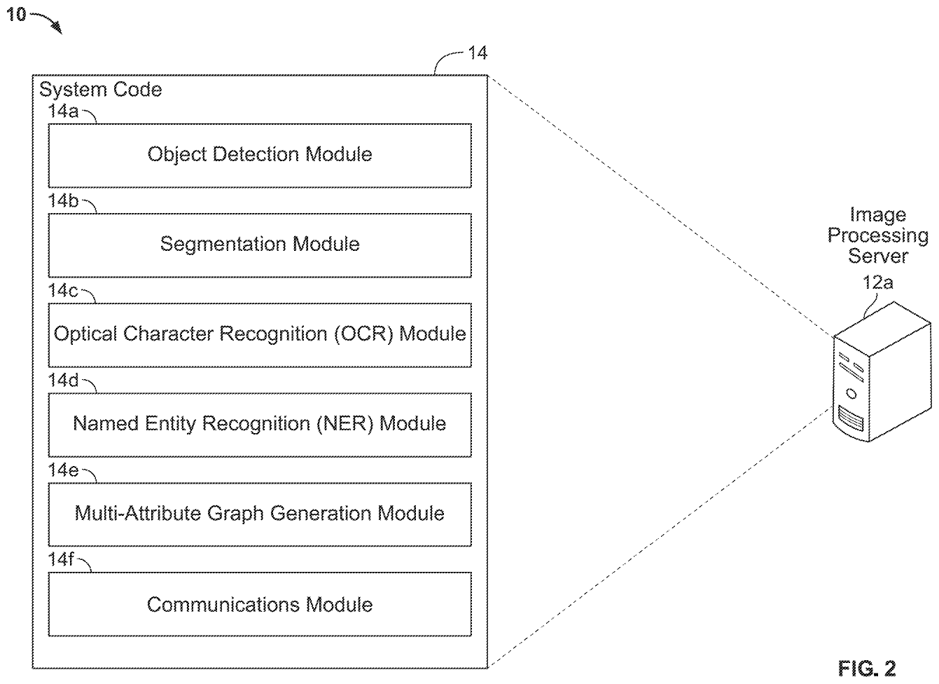

FIG. 2 is another diagram illustrating hardware and software components capable of being utilized to implement the system 10 of the present disclosure. Specifically, FIG. 2 illustrates additional aspects of the system code 14 which, when executed by one or more of the image processing servers 12a-12n, extracts information from the architectural floorplan images and generates multi-attributed graphical representations of said architectural floorplan images, as described in greater detail below. The system code 14 (i.e., non-transitory, computer-readable instructions) can be stored on a computer-readable medium and is executable by one or more of the image processing servers 12a-12n, or one or more other computer systems. The code 14 could include various custom-written software modules, or engines, that carry out the steps/processes discussed herein, and could include, but are not limited to, an object detection module 14a, a segmentation module 14b, an optical character recognition (“OCR”) module 14c, a named entity recognition (“NER”) module 14d, a multi-attribute graph generation module 14e, and a communications module 14f. The code 14 could be programmed using any suitable programming language including, but not limited to, C, C++, C #, Java, Python, or any other suitable language. Additionally, the code 14 could be distributed across multiple computer systems (e.g., the plurality of image processing servers 12a-12n) in communication with each other over the communications network 20, and/or stored and executed on a cloud computing platform and remotely accessed by a computer system in communication with the cloud platform. The code 14 could also communicate with one or more of the plurality of storage servers 16a-16n and/or plurality of floorplan image generation devices 18a-18n.

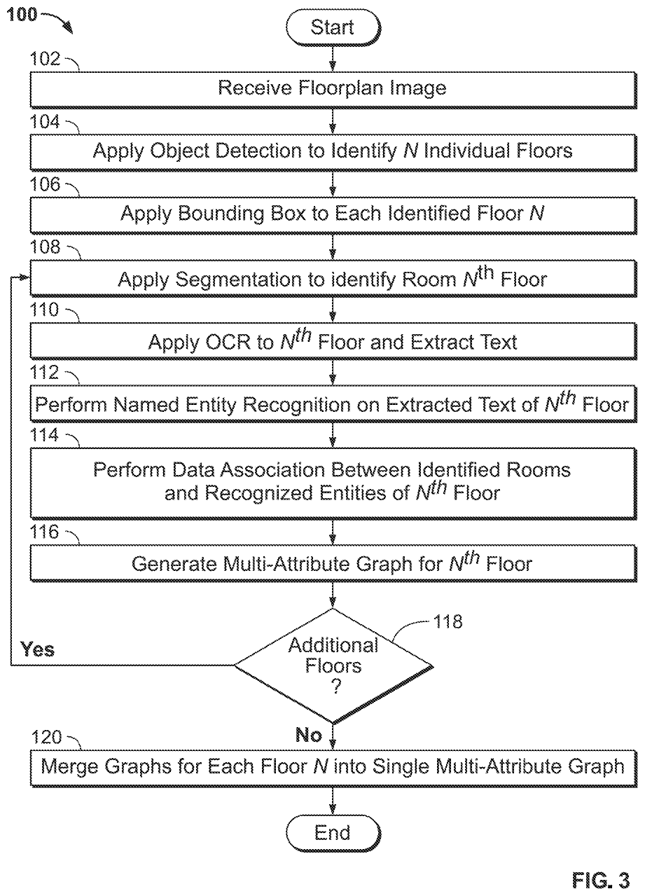

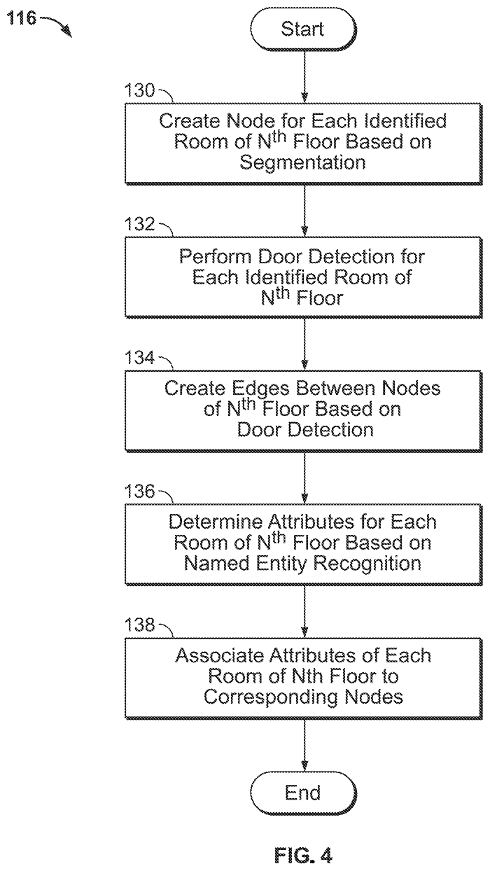

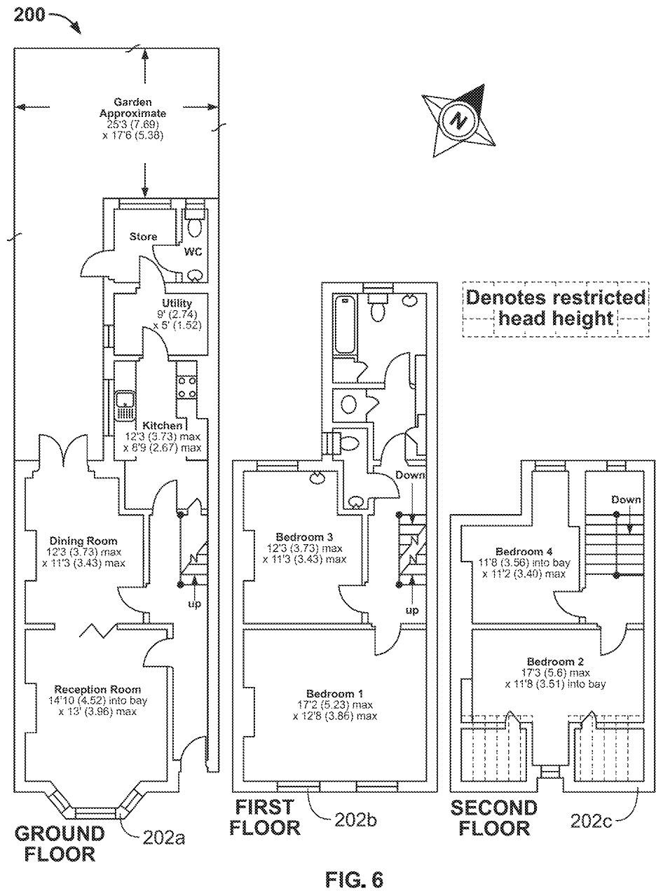

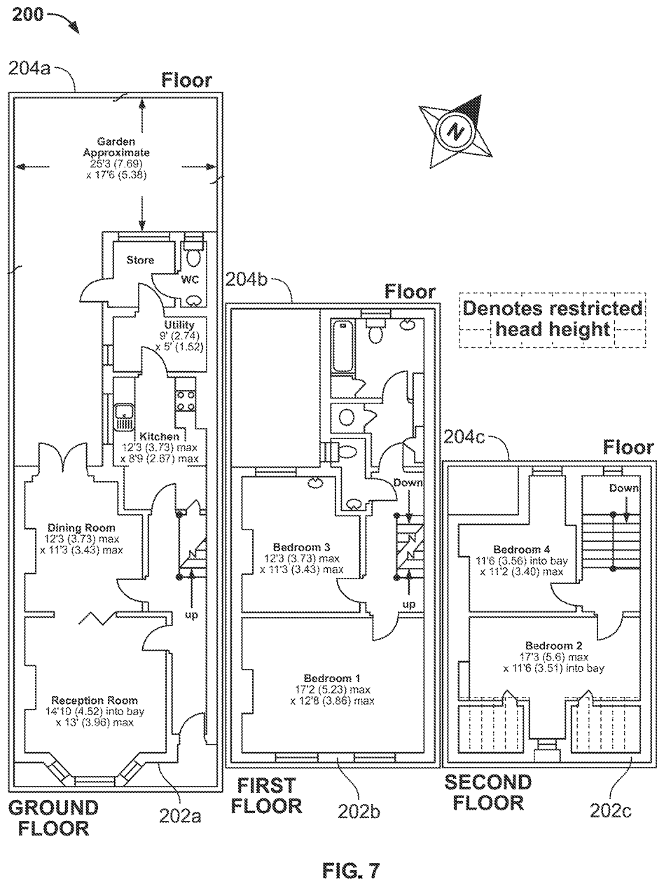

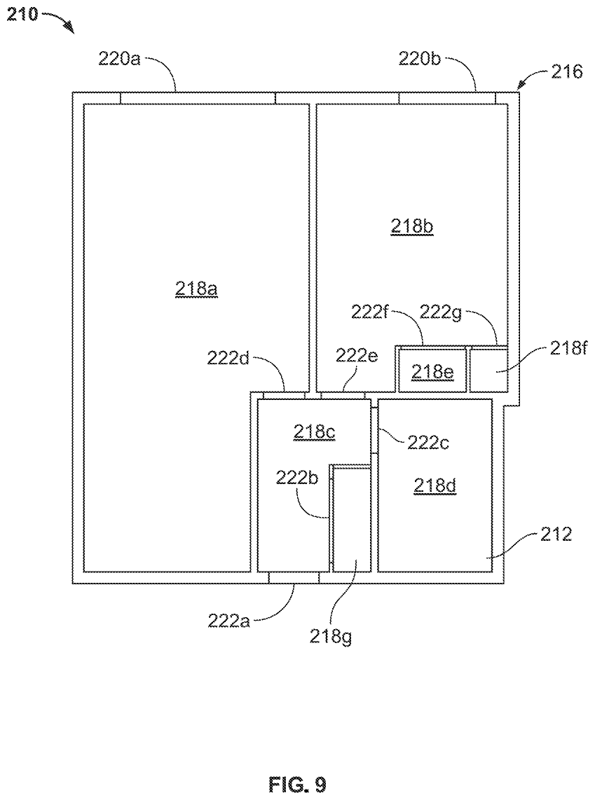

FIG. 3 is a flowchart illustrating the overall process steps 100 carried out by the system 10 of the present disclosure. In step 102, the system 10 (e.g., one or more of the plurality of image processing servers 12a-12n) receives a floorplan image (e.g., from one or more of the plurality of storage servers 16a-16n and/or the plurality of floorplan image generation devices 18a-18n). For example, FIG. 6 shows an exemplary floorplan image 200 that can be stored on one or more of the plurality of storage servers 16a-16n and later received by one or more of the image processing servers 12a-12n. In step 104, the system 10 applies object detection to the floorplan image to identify a number N of individual floors included in the floorplan image. In step 106, the system 10 applies a bounding box to each individual floor N (e.g., identified in step 104). For example, as shown in FIG. 7, the system 10 can apply one or more object detection algorithms to tighten bounding boxes 204 around identified floors 202. In step 108, the system 10 applies segmentation (e.g., by application of a segmentation network) to an N^{th} floor of the floorplan image to identify entities (e.g., rooms, windows, doors, etc.) of the NA floor (see FIG. 9). In step 110, the system 10 applies OCR to the N^{th} floor and extracts any recognized text (e.g., names of individual rooms, dimensions, and the like). In step 112, the system 10 performs named entity recognition on the text extracted from the N^{th} floor in step 110 to identify entity classes (e.g., hallways, bedrooms, bathrooms, etc.) and size information from the detected text. In step 114, the system 10 performs data association between the identified entities/rooms of the N^{th} floor (e.g., identified in step 108) and recognized entity classes of the N^{th} floor (e.g., recognized in step 112). In step 116, the system 10 generates a multi-attribute graph for the N^{th} floor, described in greater detail in connection with FIG. 4. In step 118, the system determines if there are additional floors included in the floorplan image. If a positive determination is made in step 118, the process reverts to step 108, and if a negative determination is made in step 118, the process proceeds to step 120. Accordingly, the system 10 performs steps 108-116 for each identified floor N of the floorplan image before proceeding to step 120, where the system 10 merges the multi-attribute graphs generated for each identified floor N into a single multi-attribute graph representing all of the identified floors N of the floorplan image.

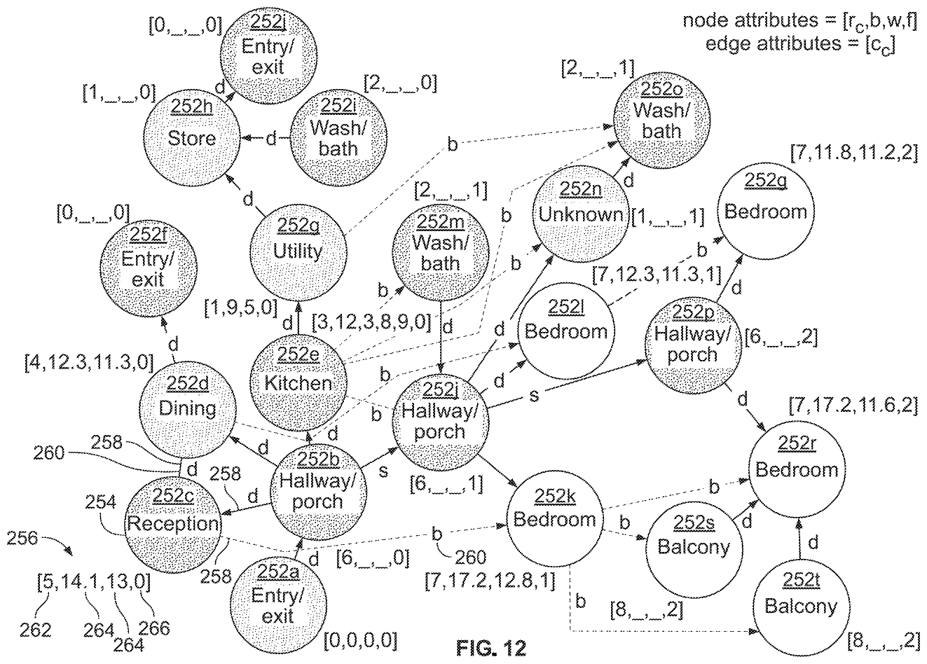

FIG. 4 is a flowchart illustrating additional process steps carried out by the system 10 of the present disclosure in connection with process step 116 of FIG. 3 for generating a multi-attribute graph for an N^{th} floor of the floorplan image. In step 130, the system 10 creates a node for each identified room of the N^{th} floor. As discussed in connection with step 108 of FIG. 3, the system 10 identifies the rooms of the N^{th} floor based on segmentation. In step 132, the system 10 performs door detection for each identified room of the N^{th} floor. It is also noted that door detection could be performed during segmentation, described in connection with step 108 of FIG. 3. In step 134, the system 10 creates one or more edges (e.g., edges 258 shown and described in connection with FIG. 12) between the nodes of the N^{th} floor (e.g., created in step 130) based on the door detection. For example, where a door connects two or more rooms of the N^{th} floor, the system 10 creates an edge corresponding to the door, between nodes of the N^{th} floor corresponding to the rooms connected by the door. In step 136, the system 10 determines attributes for each room of the N^{th} floor based on the named entity recognition performed in step 112. For example, the system 10 can determine a name of each identified room (e.g., dining room, bedroom, kitchen, bathroom, etc.) based on the named entity recognition, the system 10 can determine size and/or dimensions of each identified room (e.g., length and width) based on OCR of dimensions provided on the floorplan image, dimensioning of the room segments identified in step 108 (e.g., discussed in connection with FIG. 3), or a combination thereof, and the system 10 can determine a floor or floor number for each identified room based on the bounding box (discussed in connection with step 106) an identified room lies within and a floor number associated with the bounding box (e.g., first floor (0), second floor (1), third floor (2), etc.). The process then proceeds to step 138, where the system 10 associates the attributes of each identified room of the N^{th} floor with the nodes corresponding to each of the identified rooms.

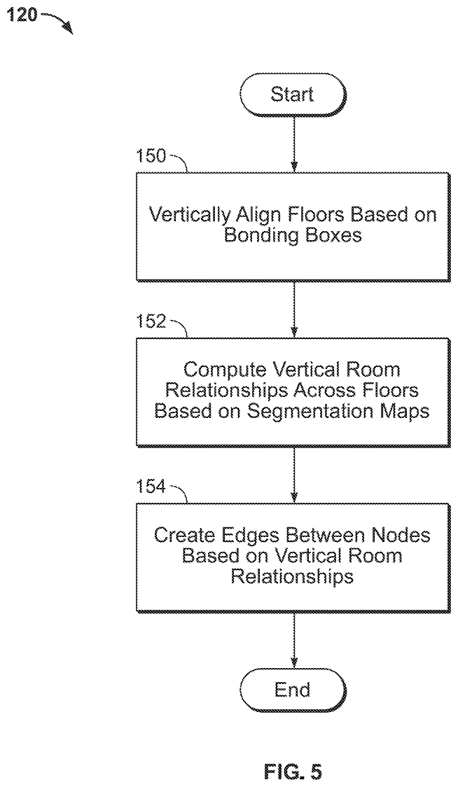

FIG. 5 is a flowchart illustrating additional process steps carried out by the system 10 of the present disclosure in connection with process step 120 of FIG. 3 for merging the multi-attributed graphs for each of the identified floors N of the floorplan image. In step 150, the system 10 vertically aligns each of the identified floors N of the floorplan image by aligning the bounding boxes applied to each of the identified floors N of the floorplan image (e.g., discussed in connection with step 104 of FIG. 3.) using the floorplan image features of external walls and staircases. With the floors vertically aligned, in step 152, the system 10 computes vertical room relationships across the floors based on the segmentation maps created by the system 10 for each of the identified floors N of the floorplan image (e.g., discussed in connection with step 106 of FIG. 3). The process then proceeds to step 154, where the system 10 creates edges (e.g., lines or vectors) between the nodes of the multi-attributed graphs for each of the identified floors N of the floorplan image, based on the vertical room relationships calculated in step 152 (see, e.g., FIG. 12). After the edges have been created between the nodes of the multi-attributed graphs, the process ends.

FIG. 6 is a diagram illustrating an exemplary floorplan image 200 that is received by the system 10 in connection with step 102 of FIG. 3. It should be understood that the floorplan image 200 can be stored on one or more of the plurality of storage servers 16a-16n before being retrieved by one or more of the plurality of image processing servers 12a-12n for analysis. As shown, the floorplan image 200 includes a ground floor 202a, a first floor 202b, and a second floor 202c. FIG. 7 is a diagram illustrating bounding boxes 204a-c applied to identified floors 202a-c of the exemplary floorplan image 200 of FIG. 6 (e.g., discussed in connection with steps 104 and 106 of FIG. 3).

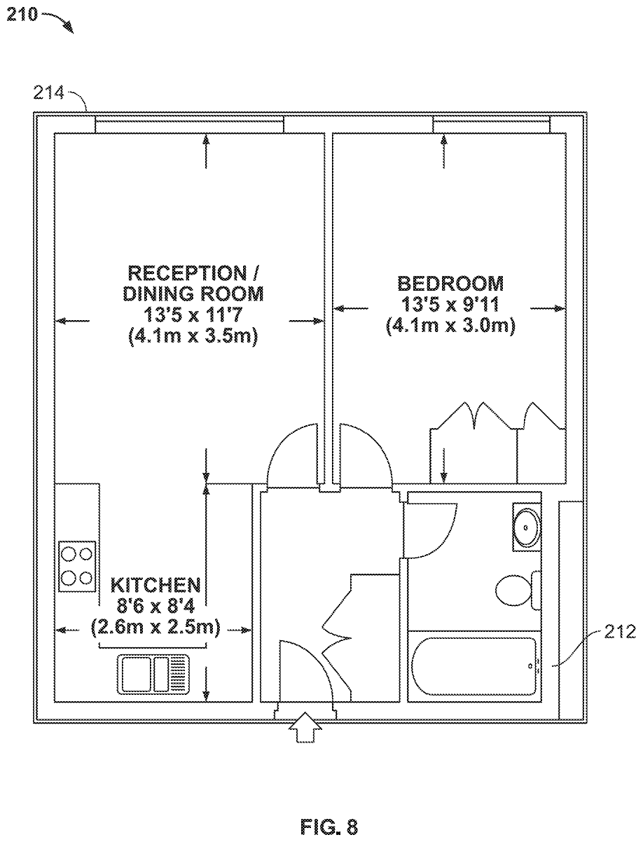

FIG. 8 is a diagram illustrating another exemplary floorplan image 210 that could be received by the system 10 in connection with step 102 of FIG. 3. As shown, the floorplan image 210 includes an identified floor 212 and the system 10 had applied a bounding box 214 to the identified floor.

FIG. 9 is a diagram showing a segmentation map 216 applied to the identified floor 212 of the floorplan image 210 of FIG. 8 (e.g., discussed in connection with step 108 of FIG. 3). As shown, the segmentation map 216 includes segments 218a-g corresponding to rooms and closets within the identified floor 212 of the floorplan image 210. The the segmentation map 216 can also include includes segments 220a-b corresponding to windows and segments 222a-g corresponding to doors within the identified floor 212 and separating one or more of the segments 218a-g of the floorplan image 210.

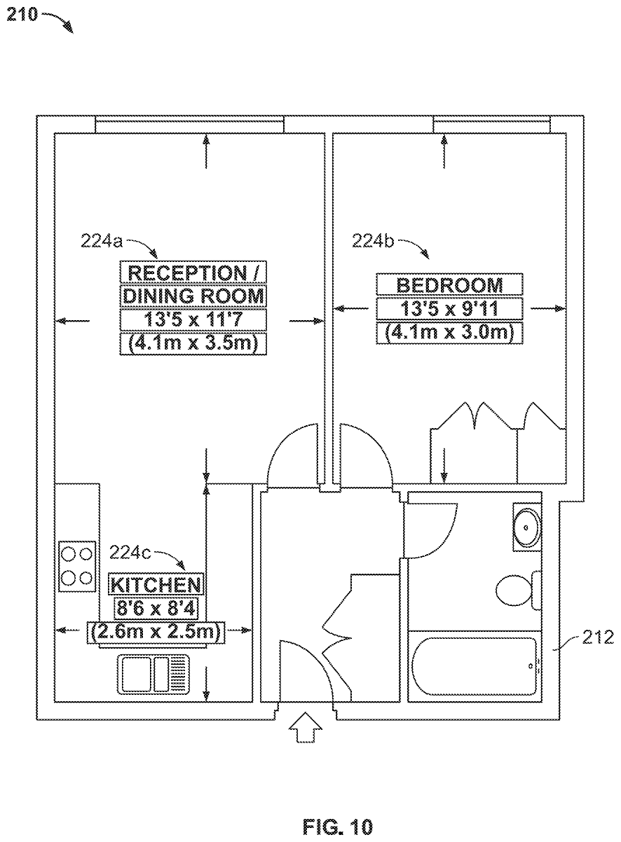

FIG. 10 is a diagram showing the application of optical character recognition by the system 10 to the identified floor 212 of the floorplan image 210 of FIG. 8 (e.g., discussed in connection with step 110 of FIG. 3). As shown, the system 10 recognizes and extracts strings of text 224a-c corresponding to the names (e.g., reception/dining room, bedroom, and kitchen) and dimensions (e.g., 13′5×11′7, 13′5×9′11, and 8′6×8′4) of one or more identified rooms of the floorplan image 210.

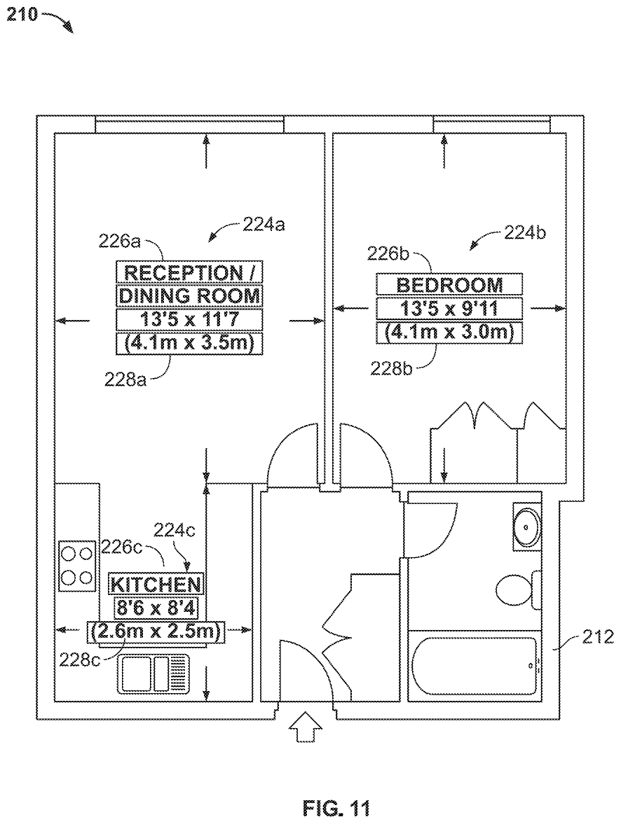

FIG. 11 is a diagram showing the application of named entity recognition (e.g., discussed in connection with step 112 of FIG. 3) to the text strings 224a-c extracted by the system 10 from the floorplan image 210 in connection with FIG. 10. As shown, the system 10 recognizes names of entities 226a-c (e.g., reception/dining room, bedroom, and kitchen) and dimensions of entities 228a-c (e.g., 13′5×11′7, 13′5×9′11, and 8′6×8′4) contained within the text strings 224a-c.

FIG. 12 is a diagram showing an exemplary multi-attributed graph 250 generated by the system 10 of the present disclosure. It should be understood that the graph 250 corresponds to the floorplan image 200, discussed in connection with FIG. 6. The graph 250 includes nodes 252a-t (together nodes 252) corresponding to identified entities (e.g., segments 218a-g, discussed in connection with FIG. 9) of the floorplan image 200 with node names 254 and node attributes 256, and edges 258 with attributes 260. For the sake of clarity, it is noted that node names 254, node attributes 256, edges 258, and attributes 260 are only indicated with reference numerals in connection with reception node 252c. However, it should be understood each of the nodes 252 are provided with node names 254, node attributes 256, and at least one edge 258 with attributes 260, shown in FIG. 12. As discussed above in connection with FIGS. 10 and 11, the node names 254 are recognized by the system 10 from extracted text (e.g., text strings 224a-c) of the floorplan image 200. The node attributes 256 can include an entity type number 262 (e.g., 0, 1, 2, 3, 4, etc.) corresponding to a type of identified entity (e.g., entry/exit, hallway, dining, kitchen, storage, bathroom, bedroom, etc.), dimensions and/or size 264 of the identified entity (e.g., 14′1×13′, shown in connection with reception node 252c), and a floor number 266 (e.g., 0, 1, 2, etc.). According to some embodiments of the present disclosure, the nodes 252 can each have a color corresponding to the type of entity, or other node attribute 256. For example, es shown in FIG. 12 entries/exits can have a first color, storage/utility closets can have a second color, bathrooms can have a third color, bedrooms can have a fourth color, and the like. The edge attributes 260 can indicate a relationship between the nodes 252, such as whether the nodes 252 are connected by a door (e.g., “d”), whether the nodes 252 are connected by a staircase (e.g., “s”), or the node attributes 260 can indicate a vertical relationship (e.g., “b”) between the nodes 252. Furthermore, the edges 258 can also indicate a relationship between the nodes. For example, an edge 258 can be an arrow, with a node attribute 260 indicating that the edge 258 is a door (e.g., “d”), and the direction of the arrow indicating the direction that the door opens. According to another example, an edge 258 can be an arrow, with a node attribute 260 indicating that the edge 258 is a staircase (e.g., “s”), and the direction of the arrow indicating the direction an individual travels to reach the next floor. According to yet another example, an edge 258 can be an arrow, with a node attribute 260 indicating indicate a vertical relationship (e.g., “b”) between connected nodes 252, and the direction of the arrow indicating the direction of the vertical relationship (e.g., indicating which node 252 is above the other). According to some embodiments of the present disclosure, the edges 258 can each have a color and/or design corresponding to the node attribute 260, such as, for example, solid line edges 258 of a first color corresponding to physically connected and/or adjoining nodes 252 and dashed line edges 258 of a second color indicating a vertical relationship between nodes 252 that are not physically connected and/or adjoining.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

1. A system for architectural floorplan image analytics, comprising:
a database for storing a floorplan image; and
a processor in communication with the database, the processor:
retrieving the floorplan image from the database;
applying object detection to the floorplan image to identify one or more floors of the floorplan image;
applying segmentation to the one or more floors of the floorplan image to identify one or more entities of the one or more floors of the floorplan image;
extracting text from the floorplan image;
preforming named entity recognition on the extracted text;
associating the one or more identified entities with one or more corresponding recognized entities;
generating one or more nodes corresponding to each recognized entity; and
creating edges between nodes having a connective relationship.

2. The system of claim 1, wherein the processor applies optical character recognition to floorplan image to extract the text therefrom.

3. The system of claim 1, wherein the processor applies a bounding box to each of the one or more floors of the floorplan image.

4. The system of claim 1, wherein the processor extracts entity size information from the extracted text and associates the extracted entity size information with a recognized entity.

5. The system of claim 1, wherein the processor extracts entity size information from the extracted text and associates the extracted entity size information with a recognized entity.

6. The system of claim 1, wherein the processor generates a multi-attributed graph for each of the one or more identified floors of the floorplan image.

7. The system of claim 6, wherein the processor merges the multi-attributed graphs for each of the one or more identified floors of the floorplan image to generate a combined multi-attributed graph corresponding to all identified floors of the floorplan image.

8. The system of claim 1, wherein the one or more nodes include associated node attributes, including one or more of an entity type, an entity size, and an entity floor.

9. The system of claim 1, wherein the edges include associated edge attributes, including a connectivity type.

10. The system of claim 9, wherein the edges indicate a directional connective relationship between adjoining rooms of a floor or a vertical connective relationship between vertically aligned rooms of different floors.

11. A method for architectural floorplan image analytics, comprising the steps of:
retrieving by a processor a floorplan image from a database;
applying object detection to the floorplan image to identify one or more floors of the floorplan image;
applying segmentation to the one or more floors of the floorplan image to identify one or more entities of the one or more floors of the floorplan image;
extracting text from the floorplan image;
preforming named entity recognition on the extracted text;
associating the one or more identified entities with one or more corresponding recognized entities;
generating one or more nodes corresponding to each recognized entity; and
creating edges between nodes having a connective relationship.

12. The method of claim 11, further comprising applying optical character recognition to floorplan image to extract the text therefrom.

13. The method of claim 11, further comprising applying a bounding box to each of the one or more floors of the floorplan image.

14. The method of claim 11, further comprising extracting entity size information from the extracted text and associates the extracted entity size information with a recognized entity.

15. The method of claim 11, further comprising extracting entity size information from the extracted text and associates the extracted entity size information with a recognized entity.

16. The method of claim 11, further comprising generating a multi-attributed graph for each of the one or more identified floors of the floorplan image.

17. The method of claim 16, further comprising merging the multi-attributed graphs for each of the one or more identified floors of the floorplan image to generate a combined multi-attributed graph corresponding to all identified floors of the floorplan image.

18. The method of claim 11, wherein the one or more nodes include associated node attributes, including one or more of an entity type, an entity size, and an entity floor.

19. The method of claim 11, wherein the edges include associated edge attributes, including a connectivity type.

20. The method of claim 19, wherein the edges indicate a directional connective relationship between adjoining rooms of a floor or a vertical connective relationship between vertically aligned rooms of different floors.
